(19) United States
(12) Patent Application Publication
(10) Pub. No.: US 2011/0111698 A1
(43) Pub. Date: May 12, 2011

(54) ELECTRONIC APPARATUS AND ACCESS CONTROL METHOD

(75) Inventor: Satoshi Odakura, Kodaira-shi (JP)

(73) Assignee: KABUSHIKI KAISHA TOSHIBA, Tokyo (JP)

(21) Appl. No.: 12/908,705

(22) Filed: Oct. 20, 2010

(30) Foreign Application Priority Data
Nov. 10, 2009 (JP) 2009-257309

(51) Int. Cl. H04B 7/00

(52) U.S. Cl. 455/41.2

(57) ABSTRACT

According to one embodiment, an electronic apparatus includes a storage device, a communication module, a connection establishing module, and a storage area information transmitter. The communication module executes close proximity wireless transfer. The connection establishing module exchanges a unique identifier of the communication module and a unique identifier of an external device between the communication module and the external device which are in a close proximity state, and establishes connection between the communication module and the external device. The storage area information transmitter specifies a storage area in the storage device which can be provided to the external device based on the unique identifier of the external device, and transmits storage area information, which includes information of a logical hierarchical structure set in the specified storage area, to the external device by the close proximity wireless transfer.

### CROSS-REFERENCE TO RELATED APPLICATIONS

This application is based upon and claims the benefit of priority from Japanese Patent Application No. 2009-257309, filed Nov. 10, 2009; the entire contents of which are incorporated herein by reference.

### FIELD

Embodiments described herein relate generally to an electronic apparatus which executes close proximity wireless transfer, and an access control method applied to the electronic apparatus.

### BACKGROUND

In recent years, wireless communication such as near field communication (NFC) has begun to be used. A user can easily execute communication for an authentication process, an accounting process, etc., simply by performing an operation of holding an IC card over a reader/writer module of a host apparatus.

Recently, a novel close proximity wireless transfer technology, which enables high-speed data transfer between devices, has begun to be developed.

Jpn. Pat. Appln. KOKAI Publication No. 2004-362523 discloses a wireless storage device which includes a memory having storage areas used by respective host apparatuses. The wireless storage device determines whether the access is permitted or not by authentication using an authentication key sent from a host apparatus when the host apparatus has requested access to an associated storage area. In this wireless storage device, when access to the associated storage area has been requested by the host apparatus, the host apparatus is requested to transmit the authentication key, and the authentication is executed by using the transmitted authentication key.

In the wireless storage device of KOKAI Publication No. 2004-362523, it is necessary to provide an application program for registering authentication keys for the respective host apparatuses, and an application program for requesting the authentication key from the host apparatus and receiving the authentication key transmitted from a host apparatus when an access request to the storage device has been received from the host apparatus.

In addition, in the wireless storage device of KOKAI Publication No. 2004-362523, a dedicated RAM area is prepared for each of the host apparatuses, and, in accordance with a host apparatus that is to be connected, the RAM area that is to be accessed by the host apparatus is switched. Thus, there is a possibility that it is difficult to set permission/prohibition of access to an arbitrary directory in the RAM area, or to commonly access a single RAM area by a plurality of host apparatuses.

### BRIEF DESCRIPTION OF THE SEVERAL VIEWS OF THE DRAWING

A general architecture that implements the various feature of the embodiments will now be described with reference to the drawings. The drawings and the associated descriptions are provided to illustrate the embodiments and not to limit the scope of the invention.

FIG. 1 is an exemplary block diagram showing the structure of an electronic apparatus according to an embodiment.

FIG. 2 shows an example of close proximity wireless transfer executed between the electronic apparatus of the embodiment and an external device.

FIG. 3 shows an example of software architecture for controlling close proximity wireless transfer, which is applied to the electronic apparatus of the embodiment.

FIG. 4 is an exemplary block diagram showing a structure example of a PCL in the software architecture of FIG. 3.

FIG. 5 shows an example of a connection apparatus list including information of an external device connected to the electronic apparatus of the embodiment.

FIG. 6 is an exemplary flowchart illustrating an example of the procedure of a session start process executed by the electronic apparatus of the embodiment.

FIG. 7 is an exemplary flowchart illustrating an example of the procedure of a storage switching process executed by the electronic apparatus of the embodiment.

### DETAILED DESCRIPTION

Various embodiments will be described hereinafter with reference to the accompanying drawings.

In general, according to one embodiment, an electronic apparatus includes a storage device, a communication module, a connection establishing module, and a storage area information transmitter. The communication module executes close proximity wireless transfer. The connection establishing module exchanges a unique identifier of the communication module and a unique identifier of an external device between the communication module and the external device which are in a close proximity state, and establishes connection between the communication module and the external device. The storage area information transmitter specifies a storage area in the storage device which can be provided to the external device based on the unique identifier of the external device, and transmits storage area information, which includes information of a logical hierarchical structure set in the specified storage area, to the external device by the close proximity wireless transfer.

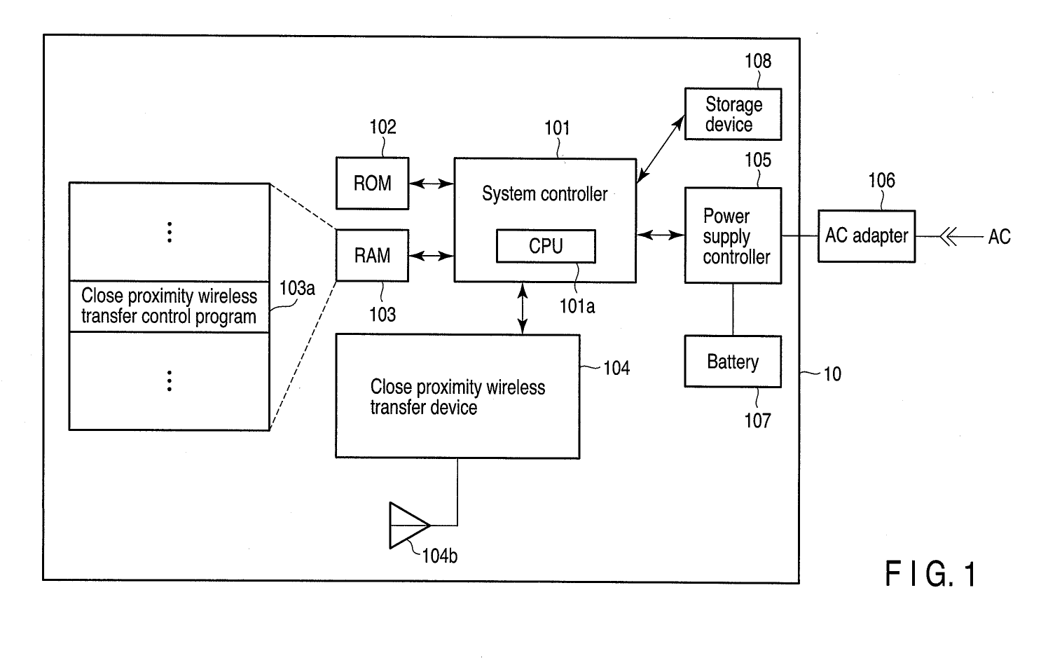

FIG. 1 shows the structure of an electronic apparatus according to an embodiment. The electronic apparatus is realized, for example, as a portable apparatus (e.g. a mobile phone, a PDA, an audio player, or an auxiliary storage medium), a personal computer, or a consumer apparatus (e.g. a TV or a video recorder). The electronic apparatus includes a communication module which executes close proximity wireless transfer, establishes wireless connection to some other device (external device) having a close proximity wireless transfer function, and executes close proximity wireless transfer with the external device in a peer-to-peer system.

This electronic apparatus 10 includes a system controller 101, a ROM 102, a RAM 103, a close proximity wireless transfer device 104, a power supply controller 105, an AC adapter 106, a battery 107 and a storage device 108.

The system controller 101 controls the operations of the respective components in the electronic apparatus 10. The system controller 101 includes a CPU 101a, and is connected to the ROM 102, RAM 103, close proximity wireless transfer device 104, and power supply controller 105.

The CPU 101a is a processor which loads instructions and data, which are stored in the ROM 102, into the RAM 103, and executes required processes. In the RAM 103, a close proximity wireless transfer control program 103a which controls close proximity wireless transfer is loaded. The CPU 101a executes the close proximity wireless transfer control program 103a loaded in the RAM 103, thereby controlling the close proximity wireless transfer device 104.

The close proximity wireless transfer device 104 is a communication module which executes close proximity wireless transfer. The close proximity wireless transfer device 104 establishes wireless connection to some other device (external device) having a close proximity wireless transfer function, which is present within a predetermined distance from the close proximity wireless transfer device 104, and then starts transmission of data such as files. The close proximity wireless transfer between the close proximity wireless transfer device 104 and the external device is executed in a peer-to-peer system. The range of communication is, e.g. 3 cm. The wireless connection between the close proximity wireless transfer device 104 and the external device is enabled only when the close proximity wireless transfer device 104 and the external device are in close proximity, that is, only when the distance between the close proximity wireless transfer device 104 and the external device is decreased to the range of communication (e.g. 3 cm) or less. When the close proximity wireless transfer device 104 and the external device are brought close to each other within the range of communication, the wireless connection between the close proximity wireless transfer device 104 and the external device is established. Then, for example, the external device accesses a predetermined storage area in the storage device 108, and transmission of data by read of a data file from the predetermined storage area or write of a data file in the predetermined storage area is executed between the close proximity wireless transfer device 104 and the external device.

Identification information (ID) for uniquely identifying each of the close proximity wireless transfer device 104 and the external device is allocated to each of the close proximity wireless transfer device 104 and the external device. Specifically, a unique identifier (unique ID: UID) of the close proximity wireless transfer device 104 is stored in the close proximity wireless transfer device 104, and a unique identifier (unique ID: UID) of the external device is stored in the external device. The unique ID of each of the close proximity wireless transfer device 104 and the external device is usable, for example, as identification information for each device to identify the device of the communication target. In the present embodiment, the unique ID is used in order to specify the storage area in the storage device 108, which can be provided to the external device. In other words, the storage area in the storage device 108, which can be provided to the external device, is specified, based on the unique identifier of the external device.

In the close proximity wireless transfer, an induction electric field is used. As a close proximity wireless transfer method, TransferJet, for instance, can be used. TransferJet is a close proximity wireless transfer method which uses UWB, and high-speed data transfer can be realized.

The close proximity wireless transfer device 104 is connected to an antenna 104b. The antenna 104b is an electrode called “coupler”, and executes data transmission/reception to/from the external device by a wireless signal using an induction electric field. When the external device comes near within the range of communication (e.g. 3 cm) from the antenna 104b, the antennas (couplers) of the close proximity wireless transfer device 104 and the external device are coupled by the induction electric field, and thereby wireless communication between the close proximity wireless transfer device 104 and the external device is enabled. In the meantime, the close proximity wireless transfer device 104 and the antenna 104b can be realized as a single module.

The power supply controller 105 supplies power to the respective modules in the electronic apparatus 10 by using power supplied from the outside via the AC adapter 106 or power supplied from the battery 107. In other words, the electronic apparatus 10 is driven by an external power supply such as an AC commercial power supply, or by the battery 107. The AC adapter 106 may be provided within the electronic apparatus 106.

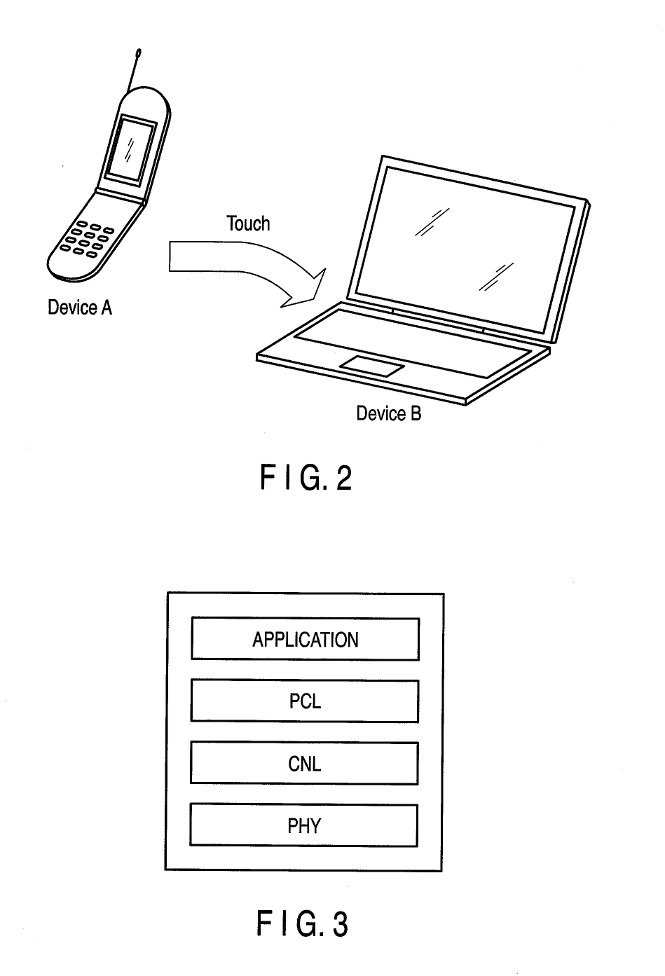

FIG. 2 illustrates close proximity wireless transfer executed between two devices.

In this case, it is assumed that a device A is a mobile phone, and a device B is a portable computer. A user performs an operation (“touch operation”) of bringing, for example, the device A close to the device B. Thereby, data transfer between the devices A and B can be started. The execution of the data transfer between the devices A and B is triggered when the devices A and B have been brought close to each other.

In each of the devices A and B, a communication program (application), which corresponds to an application protocol of any kind (e.g. SCSI, OBEX, or other general-purpose protocol), is executed. For example, when the device A has a communication program corresponding to an application protocol of SCSI, the device B recognizes the device A as a storage device if a session is established by touching the device A with the device B. By mounting the device A which has been recognized as the storage device, the device B can use the storage device in the device A as an auxiliary storage medium. In this embodiment, the “session” refers to a (virtual) communication path used for communication between the application (communication program) of the device A and the application (communication program) of the device B.

When the device A has a communication program corresponding to the application protocol of SCSI, that is, when close proximity wireless transfer is executed with the external device by using a communication adapter corresponding to the application protocol of SCSI, the storage device provided in the device A can be used from external devices such as the device B. In short, the external device can use the storage device, which is provided in the device A, as an external storage medium such as a USB memory.

However, if the storage device in the device A can be used similarly when the storage device is connected to any one of the external devices, it is possible that a problem of security arises. For example, a storage area, which stores data that is to be provided to only a first external device, can be accessed by a second external device connected to the device A, and the permission/prohibition of access to data cannot be controlled. In addition, for example, when the device A is used as an auxiliary storage medium which delivers (receives/sends) data, the device A may possibly be used by a shared personal computer, as well as by an external device, such as a personal computer, which is regularly used by the owner. Furthermore, when the device A is lost, the device A may possibly be used by a personal computer of others. The device A, which is used in the above-described manner, requires a function of switching an accessible storage area in accordance with the device that is connected.

In a method of controlling permission/prohibition of access to a device, directory or file by authentication using an authentication key or password, the list of data (e.g. directory name, file name) in the storage area or the logical hierarchical structure of data can be accessed from the external device and cannot be concealed. For example, with the display indicating a security area which requires input of, e.g. a password, or a free area which does not require input of, e.g. a password, the directory, file, etc. in the storage area are made public. Besides, the authentication key or password needs to be registered in advance by using purpose-specific software, and an application program is also needed in order to send the authentication key, etc. from the external device to the device A at the time of authentication.

Thus, in the present embodiment, based on the unique identifier of the external device which is exchanged when the connection to the external device is established, the storage area in the storage device 108, which can be provided to the external device, is specified, and storage area information indicative of the specified storage area is sent to the external device. In short, the electronic apparatus 10 switches the usable storage area in accordance with the external device. For example, based on the unique identifier (apparatus information) of the external device, the electronic apparatus 10 executes such setting that the external device, the access by which is restricted, can use only the specified storage area in the storage device 108 as a storage, and that the external device, the access by which is not restricted, can use the entire storage area in the storage device 108 as a storage.

FIG. 3 shows a software architecture for controlling close proximity wireless transfer which is executed with use of the close proximity wireless transfer device 104.

The software architecture of FIG. 3 shows a hierarchical structure of a protocol stack for controlling close proximity wireless transfer. The protocol stack includes a physical layer (PHY), a connection layer (CNL), a protocol conversion layer (PCL), and an application layer. For example, the connection layer (CNL), the protocol conversion layer (PCL) and the application layer may be realized by the wireless transfer control program 103a.

The physical layer (PHY) is a layer which controls physical data transfer, and corresponds to a physical layer in an OSI reference model. A part or all of the functions of the physical layer (PHY) may also be realized by using hardware in the close proximity wireless transfer device 104.

The physical layer (PHY) converts data from the connection layer (CNL) to a wireless signal. The connection layer (CNL) corresponds to a data link layer, a network layer and a transport layer in the OSI reference model, and executes a process of establishing connection (CNL connection) between the close proximity wireless transfer device 104 and the external device, which are set in a close proximity state, and transmitting data.

The protocol conversion layer (PCL) corresponds to a session layer and a presentation layer in the OSI reference model, and is positioned between the application layer and the connection layer (CNL) for controlling establishment and release of connection between the devices A and B. The protocol conversion layer (PCL) executes management of each application (communication program) in the application layer, and executes session control. The session corresponds to a communication path between the application layer of the electronic apparatus 10 and the application layer of the external device.

The application layer includes various communication programs (applications) corresponding to various application protocols (e.g. SCSI, OBEX, and other general-purpose protocols).

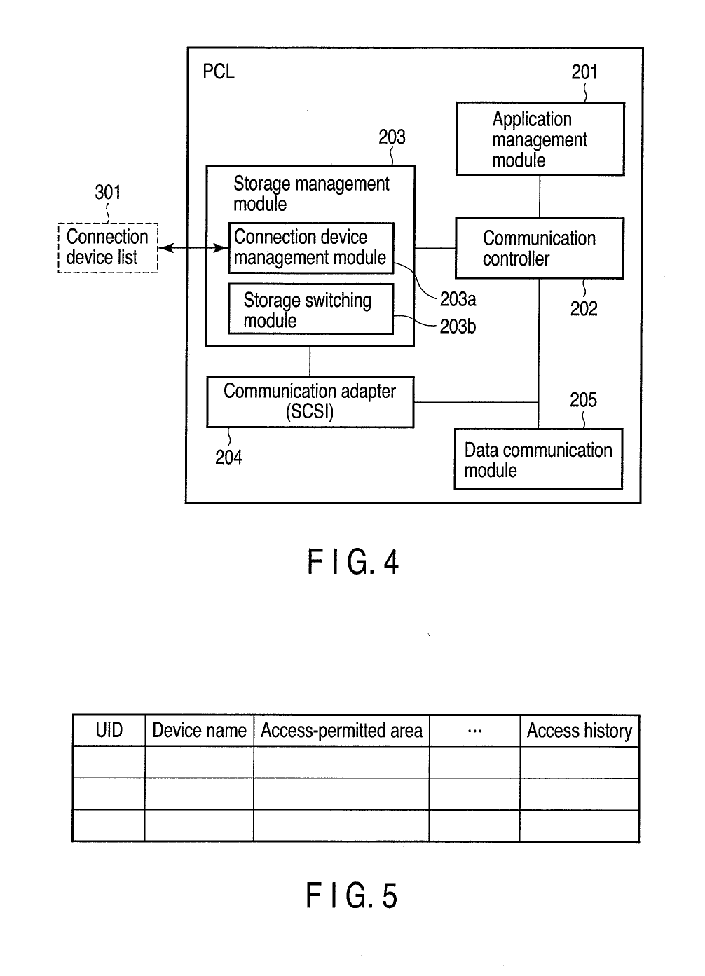

Next, referring to FIG. 4, the functional structure of the protocol conversion layer (PCL) is described.

As shown in FIG. 4, the protocol conversion layer (PCL) includes an application management module 201, a communication controller 202, a storage management module 203, a communication adapter 204 and a data communication module 205.

The protocol conversion layer (PCL) has three modes (proactive mode, reactive mode and flexible mode), and is operable in one of these three modes.

The proactive mode is a mode for a device to function as a so-called master. A device in the proactive mode can control a communication-target device and can execute a service such as data transfer between devices. The reactive mode is a mode for a device to function as a so-called slave. A device in the reactive mode can execute a service, such as data transfer between devices, under the control of a communication-target device.

The default mode of a portable device, such as a mobile phone, which cannot be driven by an external power supply, is determined to be the reactive mode in order to reduce power consumption. When an application of the portable device is operated by a user, the portable device automatically transitions from the reactive mode to the proactive mode.

The device, which is set in the proactive mode, sends a connection request signal C_Req. On the other hand, the device, which is set in the reactive mode, does not send a connection request signal C_Req and accordingly the power consumption of the device in the reactive mode is relatively small.

The flexible mode is a mode in which a device can automatically transition the own mode to the proactive mode or to the reactive mode in accordance with the mode of the communication-target device (proactive mode or reactive mode). The device in the flexible mode transitions to the reactive mode if the communication-target device is in the proactive mode. The device in the flexible mode transitions to the proactive mode if the communication-target device is in the reactive mode. The transition to the proactive mode or to the reactive mode is executed, for example, after connection between the devices is established.

The default mode of a device, such as a personal computer, which can be driven by an external power supply such as an AC adapter power supply, is the flexible mode. The device in the flexible mode sends a connection request signal C_Req. Thereby, even if the user brings the mobile phone to the personal computer (the device in the flexible mode) without operating an application of the mobile phone, the connection between the devices can be established, and the service, such as transfer of a data file, can be provided to the user under the control of the personal computer.

The application management module 201 in the PCL manages application programs (communication programs) which execute data transmission/reception by close proximity wireless transfer. The application management module 201 receives a session start request and a session end request from an application program (e.g. close proximity wireless transfer control program 103a). The application management module 201 informs the communication controller 202 of the received session start request and session end request.

In accordance with the session start request and session end request which are reported by the application management module 201, the communication controller 202 controls the start and end of communication (session), and controls the activation and stop of the communication adapter 204.

When the PCL of the electronic apparatus 10 is in the flexible mode or proactive mode, the communication controller 202 executes a process of sending the connection request signal C_Req by controlling the CNL. Responding to the C_Req transmission request from a C-Req process module 311, the CNL transmits via the close proximity wireless transfer device 104 the connection request signal C_Req including the unique ID of the close proximity wireless transfer device 104 as the ID of the source device.

The communication controller 202 detects the unique ID of the external device, which is included in the connection request signal C_Req from the external device that has been received by the CNL, and outputs the unique ID to the storage management module 203.

The communication controller 202 transmits a response signal C_Acc, which is indicative of acceptance of the received connection request signal C_Req, to the external device via the close proximity wireless transfer device 104.

Responding to the C_Acc transmission request from the communication controller 202, the CNL transmits via the close proximity wireless transfer device 104 the response signal C_Acc, which includes the unique ID of the electronic apparatus 10, that is, the unique ID of the close proximity wireless transfer device 104, as the ID of the source device, and which includes the unique ID of the external device as the ID of the destination device.

The storage management module 203 manages external devices which are connected to the electronic apparatus 10, and switches an accessible storage area in the storage device 108 in accordance with each of the external devices. Specifically, when connection to the external device by close proximity wireless transfer is established, the storage management module 203 designates which of storage areas is usable from the external device. The designated storage area is represented by, e.g. a device (storage device, etc.) in the electronic apparatus or an image file in which the hierarchical structure including directories, files, and etc. is generated as an image. The storage management module 203 includes a connection apparatus management module 203a and a storage switching module 203b.

The connection apparatus management module 203a manages, with use of a connection apparatus list 301, information relating to the external device, the connection of which to the electronic apparatus 10 by close proximity wireless transfer has been established. Specifically, the connection apparatus management module 203a adds to the connection apparatus list 301 the information of the external device, the connection of which to the electronic apparatus 10 by close proximity wireless transfer has first been established. The connection apparatus management module 203a registers the data, which includes a unique ID, an apparatus name, an access-permitted area, and an access history, in the connection apparatus list 301 as the information relating to the external device. At this time, for example, a predetermined storage area in the storage device 108 is set in the registered access-permitted area, as a storage area which can be provided to the external device that is first connected.

In addition, when connection has been established to the external device, the unique ID of which is already registered in the connection apparatus list 301, the connection apparatus management module 203a updates the information relating to the external device. The connection apparatus management module 203a updates the access history included in the data corresponding to the external device. Furthermore, the connection apparatus management module 203a updates the access-permitted area of the external device, where necessary.

FIG. 5 shows an example of data registered in the connection apparatus list 301. As described above, the data relating to each of external devices, which are connected to the electronic apparatus 10, is stored in the connection apparatus list 301. The stored data relating to the external device includes the unique ID (UID), apparatus name, access-permitted area, and access history.

The unique ID is indicative of a bit string (binary data) including a vender ID (manufacturer ID), a device ID (apparatus ID), a product ID (model ID), and other information. The vender ID is indicative of information for identifying the manufacturer (vender) of the electronic apparatus. The device ID is indicative of information for identifying the category, etc. of the electronic apparatus. The product ID is indicative of product identification information such as a model name of the electronic apparatus. The other information may include, for instance, the serial number allocated to the product. The positions in the unique ID, at which the vender ID, device ID and product ID are present, are predetermined.

The apparatus name is indicative of the name given to the external device. The apparatus name is, for example, character string information including, for instance, the maker name and model name. For example, the apparatus name may be the name of the electronic apparatus which is set by the user.

The access-permitted area is indicative of the storage area in the storage device 108, which can be provided to the external device. The access-permitted area is indicative of, e.g. a logical storage area designated by a drive or a directory. The access-permitted area may also indicate that there is no storage area in the storage device 108, which can be provided to the external device. Besides, the access-permitted area may indicate an operation (read, write, etc.) permitted with respect to the designated access-permitted area.

The access history records the number of times of access by the external device, the date/time of access, and the accessed storage area (directory, file), etc.

For example, a pair of the unique ID of the personal computer regularly used by the user and the access-permitted area indicative of the entire storage area in the storage device 108 is registered in the connection apparatus list 301. Thereby, the user can use, from the personal computer that is regularly used, the entire storage area in the storage device 108 provided in the electronic apparatus 10. A limited specified storage area in the storage device 108 is provided to a personal computer having a unique ID which is not registered in the connection apparatus list 301, that is, a personal computer which is connected to the electronic apparatus 10 for the first time.

When a service by SCSI with the external device is executed, the connection apparatus management module 203a refers to the connection apparatus list 301 and specifies the storage area in the storage device 108 which is usable (accessible) from the external device. Specifically, the connection apparatus management module 203a extracts the data corresponding to the external device by searching the connection apparatus list 301 by using the unique ID of the external device. Then, the connection apparatus management module 203a detects, from the extracted data, the information indicative of the storage area in the storage device 108, which can be provided to the external device.

The connection apparatus management module 203a outputs to the storage switching module 203b the information indicative of the storage area in the storage device 108, which can be provided to the external device. The information indicative of the storage area in the storage device 108, which can be provided to the external device, indicates, for example, that the entire storage area in the storage device 108 is accessible from the external device, that a specified storage area in the storage device 108 is accessible from the external device, or that no storage area in the storage device 108 is accessible from the external device. The connection apparatus management module 203a may change the access-permitted area in accordance with the access history registered in the connection apparatus list 301. Specifically, the connection apparatus management module 203a may change the access-permitted area in accordance with, e.g. the frequency of access from the external apparatus. Besides, the connection apparatus management module 203a may classify connected external apparatuses into groups, and may determine the access-permitted area for each of the groups.

Based on the information detected by the connection apparatus management module 203a, the storage switching module 203b sets the storage area in the storage device 108, which can be provided to the external device. Then, the storage switching module 203b outputs to the communication adapter 204 an instruction which enables the external device to use the set storage area in the storage device 108.

The communication adapter 204, as described above, converts data (user data) generated in accordance with a protocol, to which the application program corresponds, to data of a predetermined transmission data format. The communication adapter 204 may include conversion modules (communication adapters) which convert data to data of transmission data formats in accordance with application protocols. In other words, the PCL may include communication adapters corresponding to application protocols such as SCSI, OBEX and other general-purpose protocols. Thus, the communication adapter 204 includes, for example, a communication adapter module that converts data, which is transmitted/received by an application corresponding to SCSI, to a transmission data format which can be handled by the data communication module 205, a communication adapter module that converts data, which is transmitted/received by an application corresponding to OBEX, to a transmission data format which can be handled by the data communication module 205, and a communication adapter module that converts data, which is transmitted/received by an application corresponding to some other general-purpose protocol, to a transmission data format which can be handled by the data communication module 205. The communication adapter 204 outputs the converted data to the data communication module 205.

The PCL of the present embodiment includes the communication adapter 204 corresponding to the protocol of SCSI. The communication adapter 204 corresponding to the protocol of SCSI reports to the external device the information of the storage area in the storage device 108, which can be used by the external device as a storage. Specifically, the communication adapter 204 corresponding to the protocol of SCSI converts to a predetermined transmission data format the storage area information indicative of the storage area in the storage device 108 which is usable from the external device and is set by the storage switching module 203b (the storage area in the storage device 108 which can be provided to the external device). This storage area information includes the information indicative of the logical hierarchical structure in the storage area. The information indicative of the logical hierarchical structure is, for example, information indicative of the hierarchical structure including directories and files, and a so-called image file (e.g. ISO image) can be used as this information. The communication adapter 204 outputs the data of the converted storage area information to the data communication module 205.

The data communication module 205 transmits to the external device the data of the storage area information that has been converted by the communication adapter 204. In addition, the data communication module 205 controls the transmission/reception of data, control signals, etc. which are designated by the application program, etc. The operation information on the storage area (e.g. image file) by the external device is sent to the communication adapter 204 via the data communication module 205, and the operation indicated by the operation information is reflected on the corresponding storage area (directory, file, etc.) in the storage device 108.

By the above-described structure, the electronic apparatus 10 specifies the storage area in the storage device 108, which can be provided to the external device, by using the unique ID of the external device which is exchanged at the time of connection to the external device. The electronic apparatus 10 transmits the information indicative of the specified storage area to the external device, and is able to start the operation of accessing the specified storage area from the external device, without requiring an input of the password from the external device. Moreover, information of storage areas, which are not provided to the external device, can be concealed.

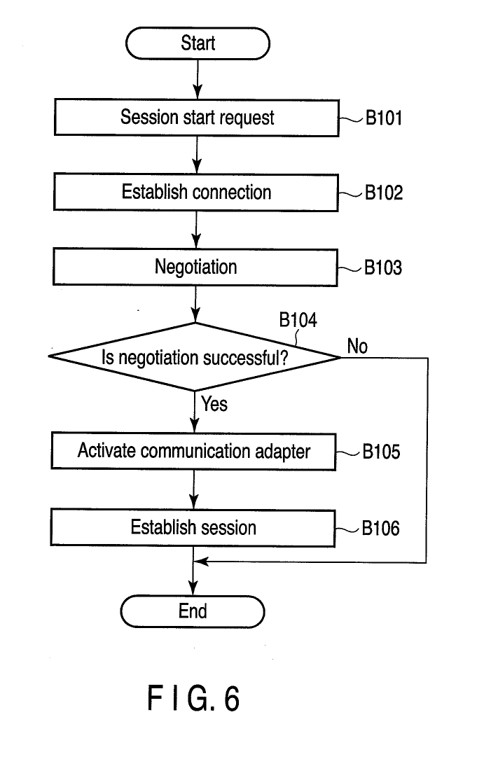

Next, referring to a flowchart of FIG. 6, a description is given of an example of the procedure of a session start process executed by the electronic apparatus 10.

To start with, the application management module 201 receives a new session start request from an application program (e.g. close proximity wireless transfer control program 103a) (block B101). The application management module 201 notifies the communication controller 202 of the reception of the session start request. The communication controller 202 establishes, via the data communication module 205, (physical) connection between the electronic apparatus 10 (the close proximity wireless transfer device 104) and the external device (block B102).

After the connection between the electronic apparatus 10 and the external device is established, the communication controller 202 executes a negotiation process with the external device, which is necessary for establishing a session between the application layer of the electronic apparatus 10 and the application layer of the external device (block B102). The communication controller 202 exchanges, with the external device, the session information of the session that is to be established, for instance, information indicative of the communication adapter (protocol), information which identifies the application (service), etc.

The communication controller 202 determines whether the negotiation process has successfully been carried out (block B104). If the negotiation process has successfully been carried out (YES in block B104), the communication controller 202 activates the communication adapter 204 corresponding to the user protocol determined by the negotiation process (block B105). The activated communication adapter 204 is, for example, a communication adapter for executing a service corresponding to the protocol of SCSI. The communication controller 202 establishes the session for executing the service (data transmission) corresponding to the user protocol (block B106). In the data transmission, packets are transmitted between electronic apparatuses. As such packets, packets to which a header including the unique ID of a source device and the unique ID of a destination device is added may be used. Since the unique IDs of the devices which are brought close to each other have already been exchanged in the connection establishment process sequence, the data transmission can immediately be started after the completion of the connection establishment process.

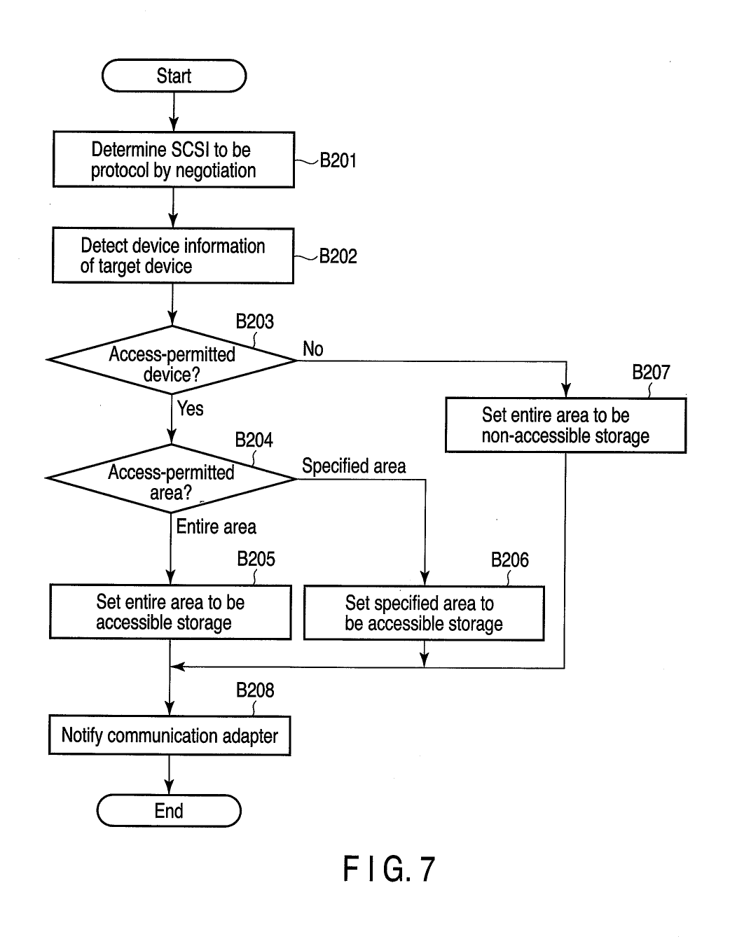

FIG. 7 is a flowchart illustrating an example of the procedure of a storage switching process executed by the electronic apparatus 10. It is assumed that a service corresponding to the protocol of SCSI is executed between the electronic apparatus 10 and the external device. Thus, the electronic apparatus 10 and external device include communication adapters which can execute the service corresponding to the protocol of SCSI.

To start with, in the negotiation (block B103) in the session start process shown in FIG. 6, the communication controller 202 determines SCSI to be the protocol that is used in the service executed between the electronic apparatus 10 and the external device (block B201). Then, the communication controller 202 detects the unique ID (apparatus information) in the connection request signal received from the external device when the session was started, or in the connection response signal sent from the external device in reply to the connection request signal sent from the electronic apparatus 10 (block B202). Specifically, the communication controller 202 detects the unique ID of the external device exchanged at the time of starting the session. The communication controller 202 outputs the detected unique ID of the external device to the storage management module 203.

Subsequently, the connection apparatus management module 203a extracts the data corresponding to the unique ID of the external device by searching the connection apparatus list 301 by using the unique ID of the external device. Then, the connection apparatus management module 203a determines whether the external device is permitted to access the storage device 108 (block B203). If the external device is permitted to access the storage device 108 (YES in block B203), the connection apparatus management module 203a specifies the storage area in the storage device 108, which can be provided to the external device (block B204).

If the storage area, which can be provided to the external device, is the entire storage area in the storage device 108 (“Entire area” in block B204), the storage switching module 203b executes such setting that the entire storage area is usable from the external device (block B205). On the other hand, if the storage area, which can be provided to the external device, is a specified storage area in the storage device 108 (“Specified area” in block B204), the storage switching module 203b executes such setting that the specified storage area is usable from the external device (block B206).

If the external device is not permitted to access the storage device 108 (NO in block B203), the storage switching module 203b executes such setting that no storage area in the storage device 108 is usable from the external device.

Then, the storage switching module 203b outputs to the communication adapter 204 an instruction which enables the external device to access the storage area which has been set to be usable in block B205 or block B206 (block B208). The communication adapter 204 transmits the storage area information, which includes the information of the logical hierarchical structure set in the storage area that can be provided to the external device, to the external device by close proximity wireless transfer via the data communication module 205.

By the above-described process, the electronic apparatus 10 specifies, based on the unique identifier of the external device, the storage area in the storage device 108 which can be provided to the external device, and transmits the information of the specified storage area to the external device. The external device can recognize, based on the information sent from the electronic apparatus 10, the storage area usable from the external device and the logical hierarchical structure of the storage area (e.g. the hierarchical structure by directories and files). When the connection to the external device is established, the electronic apparatus 10 specifies the storage area that can be provided to the external device, and does not provide the external device with the information of the other storage area. Thus, the storage area, other than the storage area that can be provided, can be concealed from the connected external device, and the security can be enhanced.

As has been described above, according to the present embodiment, the storage area in the storage device, which can be provided to the external device, can be specified without using an authentication key. Based on the unique identifier (ID) of the external device, which is exchanged when the connection by close proximity wireless transfer is established, the electronic apparatus 10 specifies the storage area in the storage device, which can be provided to the external device. Thus, it is not necessary to provide an application program for registering an authentication key (password) of the external device, or a program for authenticating access to the storage device 108. Besides, the electronic apparatus 10 does not switch the permission/prohibition of the access to the storage device 108 in accordance with the connected external device, but the electronic apparatus 10 switches the storage area in the storage device 108 which is accessible from the external device. Thus, the information, which is indicative of the storage area that can be provided to the external device, is transmitted to the connected external device, and the information of the other storage area is concealed. In short, the presence itself of the directories, files, etc. in the storage area that is not provided to the external device can be concealed from the external device.

All the procedures of the session start process and storage switching process according to the present embodiment may be executed by software. Thus, the same advantageous effects as with the present embodiment can easily be obtained simply by installing a program, which executes the procedures of the session start process and storage switching process, into an ordinary computer through a computer-readable storage medium.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a storage device;
a communication module configured to execute close proximity wireless transfer;
a connection establishing module configured to exchange a unique identifier of the communication module and a unique identifier of an external device between the communication module and the external device which are in a close proximity state, and to establish connection between the communication module and the external device; and
a storage area information transmitter configured to specify a storage area in the storage device which can be made available to the external device based on the unique identifier of the external device, and to transmit storage area information comprising information of a logical hierarchical structure set in the specified storage area, to the external device by the close proximity wireless transfer.

2. The electronic apparatus of claim 1, wherein the unique identifier of the external device comprises at least one of a vender identifier, a device identifier and a product identifier.

3. The electronic apparatus of claim 1, further comprising a connection apparatus management module configured to manage a connection apparatus list in which a unique identifier of respective one or more external devices and information indicative of storage areas in the storage device are registered, the storage areas being areas which can be made available to the external device,
wherein the storage area information transmitter is configured to detect information indicative of a storage area in the storage device, which can be made available to the external device from the connection apparatus list, based on the unique identifier of the external device, and to specify the storage area in the storage device, which can be made available to the external device, by using the detected information.

4. The electronic apparatus of claim 3, wherein the storage area information transmitter is configured to determine a predetermined storage area in the storage device to be the storage area which can be made available to the external device, when the unique identifier of the external device is not registered in the connection apparatus list.

5. The electronic apparatus of claim 3, wherein the connection apparatus management module is configured to record a history of access from the external device to the storage device in the connection apparatus list, and
the storage area information transmitter is configured to determine the storage area in the storage device which can be made available to the external device based on the history of access in the connection apparatus list.

6. The electronic apparatus of claim 1, wherein the connection establishing module is configured to determine a service executed between the communication module and the external device by executing a negotiation process between the communication module and the external device.

7. The electronic apparatus of claim 6, wherein the service comprises a service of Small Computer System Interface (SCSI).

8. An access control method of controlling access to a storage device in an electronic apparatus which comprises a communication module configured to execute close proximity wireless transfer, the method comprising:
exchanging a unique identifier of the communication module and a unique identifier of an external device between the communication module and the external device which are in a close proximity state, and establishing connection between the communication module and the external device; and
specifying a storage area in the storage device which can be made available to the external device based on the unique identifier of the external device, and transmitting storage area information, which comprises information of a logical hierarchical structure set in the specified storage area, to the external device by the close proximity wireless transfer.

9. A non-transient computer readable medium having stored thereon a computer program for controlling access to a storage device in an electronic apparatus which comprises a communication module configured to execute close proximity wireless transfer, that when executed by a computer, causes the computer to:
exchange a unique identifier of the communication module and a unique identifier of an external device between the communication module and the external device which are in a close proximity state;
establish connection between the communication module and the external device;
specify a storage area in the storage device which can be made available to the external device based on the unique identifier of the external device; and
transmit storage area information, which comprises information of a logical hierarchical structure in the specified storage area, to the external device by the close proximity wireless transfer.
